(19) United States
(12) Patent Application Publication
(10) Pub. No.: US 2006/0085327 A1
(43) Pub. Date: Apr. 20, 2006

(54) Systems and methods for using credit card in government purchasing transactions

(76) Inventor: Gary F. Green, Phoenix, AZ (US)

Correspondence Address: TRAN & ASSOCIATES, 6768 MEADOW VISTA CT., SAN JOSE, CA, 95135, US

(21) Appl. No.: 10/966,387

(22) Filed: Oct. 15, 2004

(51) Int. Cl. G06Q 40/00

(52) U.S. Cl. 705/39

(57) ABSTRACT

Systems and methods to support an electronic market place include a communication network to communicate purchase requests; one or more buyers coupled to the network to issue a purchase order specifying items from two or more suppliers; and a server coupled to the network to receive the purchase order, the server generating sub-orders from the purchase order and sending the sub-orders to the two or more suppliers for fulfillment.

### BACKGROUND

In 1998, the GSA awarded five contracts to provide federal agencies with a new way to pay for commercial goods and services, as well as travel and fleet-related expenses. The GSA SmartPay® contracts were effective from Nov. 30, 1998 through Nov. 29, 2003, with the first of five one-year option periods exercised extending the period of performance to Nov. 29, 2004. Awards were made to five service providers: Bank of America, Bank One, Citibank, Mellon Bank and U.S. Bank.

Federal cardholders use the GSA-SmartPay program to pay for a wide variety of goods and services. In FY2003, this amounted to over $23 Billion for all card types. The major types of charge cards issued are Purchase Cards—used to pay for the acquisition of goods and services and represents about 70.5% or the program volume. Another type charge card is called Travel Cards—used to pay for official Government travel and represents about 27% of the program volume. Yet another type is called Fleet Cards—used to pay for fuel and vehicle maintenance and repair and represents about 2.5% of the program volume. Another type known as Integrated Cards provides the convenience of combining the capabilities of several of the other card types in one product.

In using the cards, buyers in need of goods and services often spend considerable time locating an appropriate vendor. Buyers use trade publications, directories, recommendations, and other means to locate vendors. If the type of vendor needed is in a foreign country, the problem compounds. Vendors advertise through various media and by direct sales methods to make known to potential buyers what they sell and how to contact them. Once a buyer identifies a few vendors, each must be contacted to obtain product or service, price and availability information. This is a time-consuming process and companies typically rely on experienced purchasing staff to accomplish it. In addition, when buyers must sell surplus inventory from time to time, they must advertise, cold-call, sell to brokers or the like. These processes are costly and time-consuming for most businesses.

As discussed in U.S. Pat. No. 6,556,976, the prior art includes computerized shopping systems that employ a central database of goods and services offered to buyers. Information about the goods and services offered is stored centrally and must be kept current centrally. The volume of information required to be maintained and updated in a central database system restricts it to a limited type or number of goods and services or number of vendors it can offer. These systems are like electronic supermarkets that are owned by a single company or an association of suppliers. In such systems, a vendor provides its database of goods and/or services to a buyer who orders items from the vendor's database. It is analogous to walking into a vendor's store and selecting items from the vendor's available stock. Another such system is analogous to shopping in a mall. In this case a number of (complementary) vendors combine to offer their collective inventory to the buyer through individual databases or a combined database of available goods or services. In yet another existing system, a primary, seller, such as an insurance agency, offers to provide buyers premium quotations from the insurance carriers for which the agency is an agent. In all of the above cases, the vendors responding to the buyer's request regarding a particular good or service are either the service provider or a vendor with whom the service provider is involved in another business relationship, such as advertisers in a common publication or affiliated insurance carrier. These select vendors provide the product and pricing information supplied by the system to buyers.

In a related trend, many bank accounts are reconciled manually by customers. A customer visually compares a printed bank statement and corresponding customer accounting information. The visual process tends to be time-consuming, tedious, and error-prone. To address this issue, U.S. Pat. No. 5,134,564 discloses a method of reconciling a first list (a bank statement) formed of a first number of first records and a second list (bank customer's list of records) formed of a second number of second records where the records affect the account balance for the bank statement.

### SUMMARY

Systems and methods to support an electronic market place include a communication network to communicate buying and selling requests between buyers and vendors; a buyer for the government coupled to the network to issue a purchase order and to provide a credit card number; and a server coupled to the network to receive the purchase order, the server charging the credit card number for the purchase order, the server further accessing data from a Central Contract Registry (CCR) Database to retrieve vendor payment data for paying the vendor.

Means for tracing and auditing each transaction are provided. Once the government employee uses the government credit card for a purchase, he/she is required to enter the details of the purchase into the system. Upon receipt of the account statement from the bank, the particular account may be picked for an audit. Since all the details of each purchase are in the system, each purchase is easily auditable. The system captures level three data. In the meantime a partnership between the chosen bank and the system provides the government with auditable and traceable data.

In one embodiment, the system matches transactions to avoid false reporting of two transactions when only one occurred. The credit card transactions have a reference number so that would probably be the point of integration. In the event that the banking partner has level three information on their statement, that data is compared against information that the cardholder entered into the system to determine a match or mismatch, and if mismatches occur, the system flags the mismatches for investigation.

The transaction matching reduces the incidence of fraud for two reasons. One is that an audit can be performed and the second is that each cardholder will know that each transaction is auditable, thereby creating the desired psychological effect on the cardholder.

Advantages of the invention may include one or more of the following. The system allows merchants and merchant banks to provide detailed information regarding each transaction. By combining the information-rich data included in every transaction over the system with the robust operational capabilities of the most advanced banks, each transaction becomes eminently traceable and auditable. Since audits are easily accomplished, card abuses are mitigated and the incidence of fraud is reduced. Other benefits of the system include a streamlined purchasing process that eliminates the use of purchase orders and reduces administrative costs; an improved payment process that allows fully automated invoicing and payment processing; performance based refunds for agencies based on net charge volume; and electronic access systems that allow for streamlined financial operations and allocation methods.

Other advantages may include one of the following. The system reduces the cost and complication of automating commerce communications and transactions to help users reduce overhead, strengthen relationships, and improve profitability. Additionally, the system can handle a large number of goods and services from any number of vendors who wish to become members of the system. The scalable distributed database can handle sizable information about products, services and vendors. Each vendor can provide detailed information to the central database about its product lines and can update the database on a timely basis.

### BRIEF DESCRIPTION OF THE DRAWINGS

Embodiments of the invention will now be described with reference to the accompanying drawing, in which:

FIGS. 1A-1D show an exemplary architecture for serving buyers and sellers with a government data repository.

FIG. 2 illustrates an exemplary logical architecture in accordance with one aspect of the invention.

FIG. 3 illustrates an exemplary multi-vendor ordering process using a government credit card.

FIG. 4 illustrates a communications network between a Central Contract Registry (CCR) Database and a system database for handling orders.

FIG. 5 illustrates an exemplary CCR update process.

FIG. 6 illustrates an exemplary vendor registration process.

FIG. 7 shows an exemplary vendor profile process.

FIG. 8 shows a vendor payment process.

FIG. 9 shows an exemplary process to locate a particular vendor.

### DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments may be possible.

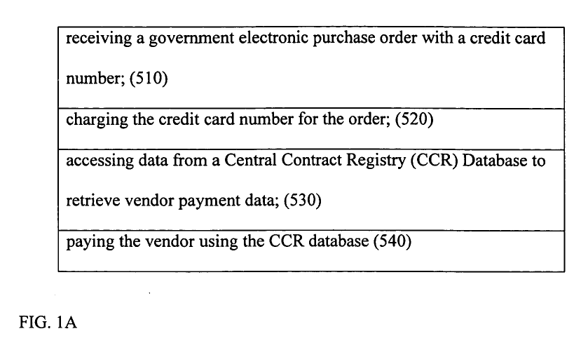

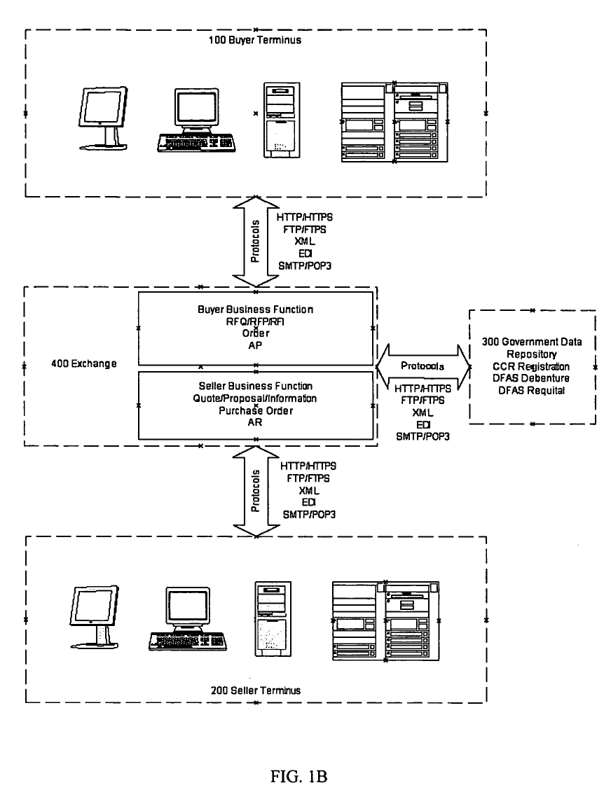

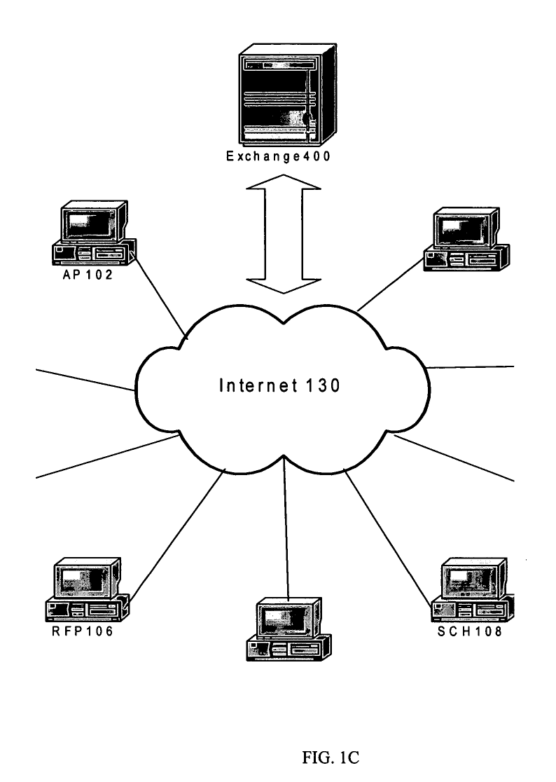

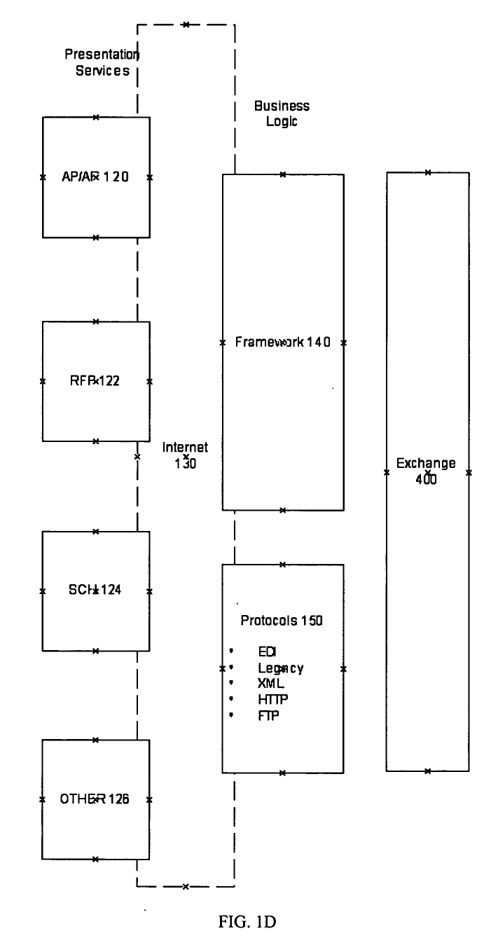

FIG. 1A shows an exemplary process to buy and sell items with the credit card and a CCR. First, the process receives a government electronic purchase order with a credit card number (510). Next, the system charges the government credit card number for the order (520). Upon delivery of the items purchased, the system then accesses a Central Contract Registry (CCR) Database to retrieve vendor payment data (530); and pays the vendor using the CCR database (540).

In one embodiment, the system matches transactions to avoid false reporting of two transactions when only one occurred. The credit card transactions have a reference number so that would probably be the point of integration. In the event that the banking partner has Level 3 information on their statements, that data is compared against information that the cardholder entered into the system to determine a match or mismatch, and if mismatches occur, the system flags the mismatches for investigation. Level 3 information contains full data detailing the purchase, i.e.; what was bought, by who, how much, among others.

The system keeps computerized information of all transactions that affect the agency's money accounts. Such transactions may be originated by the government agency, a bank, or a third party. The transactions may or may not originate with paper documents, and ins such cases the system converts the transactions to electronic information and stores them in computer files. At accounting intervals known as statement cycles, the system provides each governmental agency customer with a summary list of all transactions affecting the customer's account.

The system can reconcile a first list formed of a first number of first records and a second list formed of a second number of second records. The first list is typically a list of transactions affecting the account balance that have occurred during the accounting period for the statement. The second list is typically the customer's own list of records including the charges and other transactions affecting the customer's account balance.

For each unmatched record in the first list, a corresponding record from the second list is selected based upon a match value. Whenever the match value exceeds a threshold value, the corresponding records from the first and second lists are paired and thereafter, are removed from further reconciliation processing. The match value is determined as a result of comparing record elements and other attributes of records from the first and second lists. The highest match value for an unmatched record in the second list relative to a selected record in the first list is proposed as a match. The probable match, as determined by the highest match value, is selected or rejected either by human intervention or by automatic processing. For each probable match accepted, the accepted match pair, including a record from the first list and a record from the second list, is then removed from further processing. The probable matching steps are repeated until all acceptable probable matches have been determined. Thereafter, if unmatched records exist in the first list, further processing continues. For example, if no probable match exists, it may be determined that the lack of a likely match results from the omission of a record in the second list and the match can be made by insertion of a corresponding record in the second list so that a matched pair in the first and second list results. More details on the matching process are discussed in U.S. Pat. No. 5,134,564, the content of which is incorporated by reference.

Referring now to FIG. 1B, an exemplary architecture for on-line commerce is shown. A buyer 100 such as a federal or state government, a conglomerate, or a pooled purchasing group typically buys from many suppliers. The system of FIG. 1B provides a single point of contact for the buyer 100 to centralize administrative and financial operation support.

The buyer 100 has a group of one or more purchasing agents connecting to the marketplace. A purchasing agent may have shared interests in particular commodities, or may not have any commonality in their purchases. The purchasing agents access data from an exchange 400 operated by an intermediary company typically through common Internet based protocols.

A seller 200 can be an individual seller or a seller community with one or more vendors or suppliers. The seller community can communicate directly with users of the purchasing workstations or indirectly through the server. The community provides the client workstations with access to a network of sellers that can enhance the purchasing experience. For rapid market penetration and to prevent channel conflict problem, the system can integrate third parties into its business models as partners and also as (micro-) aggregators of supply and demand.

In addition to the proprietary or Internet network, users can also communicate with the exchange 400 by sending facsimiles to one or more fax-modem boards that communicate with a server at the exchange 400. Upon receipt, the facsimiles are fed through an optical character recognition (OCR) software or subassembly. The OCR software or hardware in turn generates one or more files that can be processed by the server as though the information had been received over the Internet. In this manner, the system of FIG. 1B supports buyers who are not fully Internet-enabled.

The system of FIG. 1B also includes a Government Data Repository 300, which is a federation of data and standards used for exchanges between buyers and sellers. The Government Data Repository 300 provides the Exchange 400 with data allowing for pre-registration of Buyers 100 and Sellers 200. Using pre-registration allows the Buyer 100 or Seller 200 to gain access to the Exchange 400 with only the entry of identity validation credentials.

The exchange 400 is the aggregation of facilities for interaction with the buyer 100, the seller 200, and the Government Data Repository 300. The exchange 400 uses an application framework consisting of a core base object library with database abstraction, table-to-association mapping, database scalability and transaction mapping, and an integrated business class generator with business-rule support, and an object-to-relational map interface. The application framework decouples the DB design from the object class design, standardizes the code base, provides for seamless object and DB tier scalability, allows ultra-thin client access, an efficient testing cycle, and a fast prototype-to-production cycle.

Although the exchange 400 can be services provided by an individual server, typically the exchange 400 is a cluster of redundant servers and services. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The exchange 400 can also be protected by a firewall. The exchange 400 supports a reservation transaction portal that provides a single point of integration, access, and navigation through the multiple enterprise systems and information. The exchange 400 allows a purchasing agent to log onto a computerized purchasing system over a network and automates the steps required to complete a purchase transaction. Using the exchange 400, the purchasing agent would be able to use specific criteria and parameters to rapidly search through a large database of available suppliers. Buyers 100 and sellers 200 get several support services and document templates during the whole process. The system provides these services, of which, some are basic and some are value added. In addition, information relating to the various portions of a transaction are captured and stored in a single convenient location where it can be accessed at any time.

The exchange 400 contains high-performance virtual protocols that exchange information with Buyers 100, Sellers 200, and Government Data Repository 300. These protocols bypass conventional disk or other media based staging areas and operate directly in memory. These protocols allow exchanged data to be stored and retrieved directly with caching or database systems. The protocols for interaction between the Buyer 100 and the Exchange 400 are typically HTTP, HTTPS, FTP, FTPS, XML, EDI, SMTP, and POP3. The protocols for interaction between the Seller 200 and the Exchange 400 are typically HTTP, HTTPS, F 1'P, FTPS, XML, EDI, SMTP, and POP3. The protocols for interaction between the Government Data Repository 300 and the Exchange 400 are typically HTTP, HTTPS, FTP, FTPS, XML, EDI, SMTP, and POPS.

The exchange 400 facilities manage foreign currency via a matched currency system that uses the same currency on each transaction for all parties to the transaction. This matched currency system avoids the typical currency fluctuation losses and gains found in systems relying upon at-transaction or post-transaction currency exchange.

The exchange 400 enables buyer(s) 100 to select one or more seller(s) 200 for procurement by ranking and comparing based upon business type, cost, performance, desired business development qualities, location, or other characteristics. A weighted score is available to Buyer 100 to aid in selection. The exchange 400 also communicates data such as CCR registration, DFAS debenture and DFAS requital information with the government data repository 300.

Turning now to FIG. 1C, a physical computer manifestation of the architecture of FIG. 1A is shown. In FIG. 1C, a server for exchange 400 communicates over the Internet 130 with a plurality of computers 102-18 for account payable operations, account receivable operations, request for proposal operations, and seller clearing house operations, respectively. FIG. 1D shows a corresponding view of modules and their interactions. In FIG. 1D, a presentation services tier includes account payable/receivable module 120, a request for proposal module 122, a seller clearing house module 124, and other modules 126. The presentation services communicate over the Internet 130 to a business logic tier including software framework 140 and protocol handling module 150, which can translate among protocols such as EDI, legacy, XML, HTTP and FTP, among others. The framework 140 and protocol handling module 150 in turn communicate with the exchange 400.

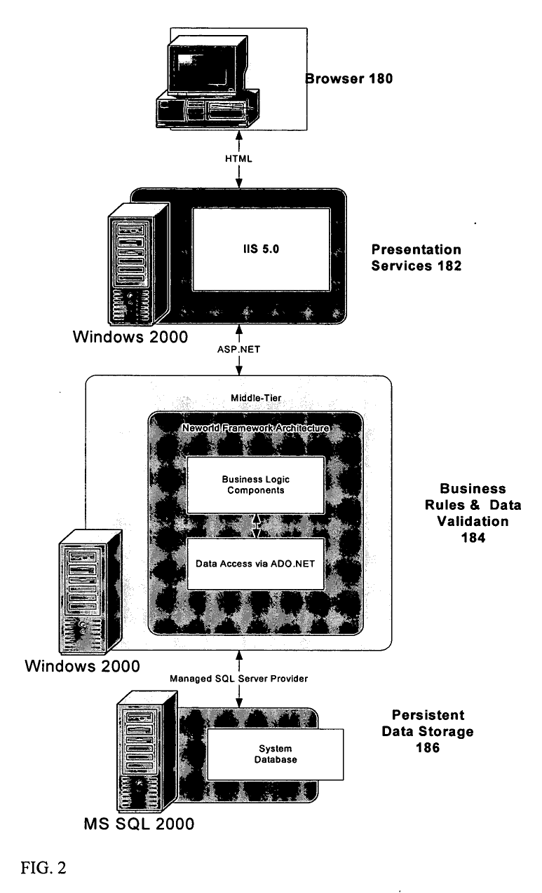

FIG. 2 illustrates an exemplary logical architecture in accordance with one aspect of the invention. A browser 180 communicates over the Internet using HTML with a server that provides presentation services 182. The server also communicates with a middle tier 184 for performing business rules and data validation using Microsoft's ASP.NET. The architecture includes business logic components that access data using ADO.NET. The middle tier 184 in turn communicates with a database in persistent data storage 186. The communication between the middle tier 184 and the persistent data storage 186 is done through a managed SQL server provider.

A multi-vendor purchase order system is supported: The buyer may fill a shopping cart (Electronic Storefront purchase) with goods from multiple vendors and proceed seamlessly to checkout. The system distributes the orders for the purchased items to the individual vendors and tracks fulfillment history, invoicing and payment individually per vendor, while preserving the buyer's purchasing history for the entire shopping cart (multi-vendor) as well as individually per vendor. During the solicitation process, the buyer may compare competing vendor's offers onscreen, providing a solid cost-based comparison for the purposes of making a purchase decision.

In one embodiment, the system hosts all participating Vendors' catalogs on its own servers. This capability is a paradigm shift in e-commerce technology away from the model where an originating website accesses and processes information on the secondary website and the secondary website then returns data to the originating website.

Instead of this model, one embodiment hosts all catalogs of registered Central Contract Registry (CCR) vendors on the system's network infrastructure. These CCR vendors must navigate to the system, register and then post a catalog themselves. The system “pulls” vendor information from CCR daily. This is high-level information such as company name, address, point of contact, etc. OMC accepts the catalog when the vendor posts the catalog, not when the vendor information gets “pulled.” Moreover, these Vendors have a choice of industry and technical formats with which to upload their catalogs, and may update the information as often as they want (e.g. more than once per day if desired).

Industry catalog formats supported by one embodiment of the system include the following:

NIGP (National Institute of Government Purchasing), URL: http://www.nigp.org/

NAICS (North American Industry Classification System), URL: http://www.census.gov/epcd/www/naics.html

UNSPSC (United Nations Standard Products and Services Code), URL: http://www.unspsc.org/

Vendors using any of the above listed industry-standard formats do not have to reorganize their information prior to upload. After receiving the catalog, the system organizes and stores the catalog in NIGP format. This is the format displayed in the browser when the Ordering Officer views the Catalogs feature.

In uploading catalogs, vendors have two choices for technical formats when uploading a catalog to the system. For small Vendors, a web-based form for manual user data-entry is provided. Large vendors may choose instead to convert their catalog data to an intermediate format known as a .cif format. In brief, the Vendor uses a highly standardized format and a Microsoft Excel spreadsheet to input the catalog data. When the catalog is finished, the Vendor converts the spreadsheet to comma-separated values (.csv file format) and uploads to the system. Vendors can update their catalogs as often as daily if they so desire.

The system allows the buyer to form a select list of vendors, to whom they will send a solicitation, and sends the solicitation to this list. The system also provides a rating system by requiring a vendor rating as the buyer approves an invoice. This creates a body of knowledge that will provide subsequent buyers valuable information about vendor performance. The system also accepts an assignment of funding: Buyers are able to “pre-fund” purchases. This means that buyers create requisitions, lines of accounting and designate amounts for spending prior to transactions. As transactions are made against these accounts, the system automatically draws down on the pre-funded amount. Funding objects include Requisitions, Funding Items (line items) and Fund Cites (account numbers).

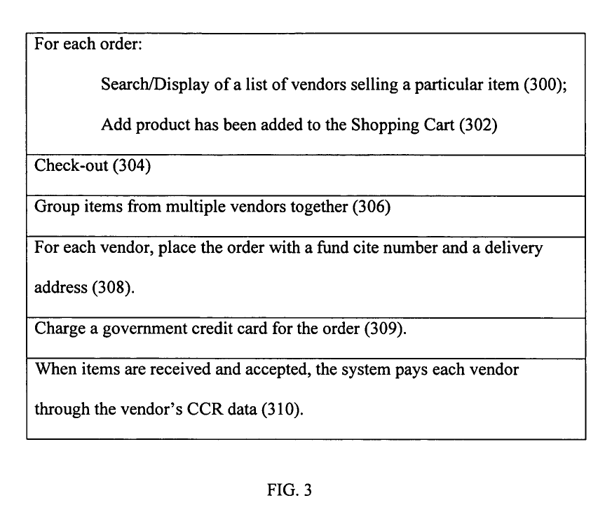

Turning now to FIG. 3, an exemplary multi-vendor ordering process is shown. For each order, the process accepts a search query from the user and display of a list of responsive vendors (300). The process allows the user to add products from different vendors into the Shopping Cart (302). This is repeated for each item the user wishes to order. When the user is done, he or she checks-out (304). In one embodiment, this is done using an electronic shopping cart. The user can pay by referencing a fund source such as a contract number or a government credit card, among others. After verifying the fund source, the process group items from the same vendor together (306), and for each vendor, place the order with a fund cite number and a delivery address (308) and charge a government credit card for the order (309). Next, when the items are received and the user indicates acceptance, the system pays each vendor through the vendor's Central Contractor Registration (CCR) data (310).

Once the government employee uses a government credit card for a purchase, he/she is required to enter the details of the purchase into the system. Upon receipt of the account statement from the bank, the particular account may be picked for an audit. Since all the details of each purchase are in the system, each purchase is easily auditable. The system contains all the so-called level three data that is missing from the statements of most banks. The chosen bank together with the system database provides the government with auditable and traceable data. This will reduce the incidence of fraud for two reasons. One is that an audit can be performed and the second is that each cardholder will know that each transaction is auditable, thereby creating the desired psychological effect on the cardholder.

The CCR is the primary vendor database for the Department of Defense (DoD), NASA, Department of Transportation (DoT), and Department of Treasury. The CCR collects, validates, stores and disseminates data in support of agency missions. Both current and potential government vendors are required to register in CCR in order to do be awarded contracts by the DoD, NASA, DoT and Treasury. Vendors are required to complete a one-time registration to provide basic information relevant to procurement and financial transactions. Vendors must update or renew their registration annually to maintain an active status. CCR validates the vendor's information and electronically shares the secure and encrypted data with the federal agencies' finance offices to facilitate paperless payments through electronic funds transfer (EFT). Additionally, CCR shares the data with several government procurement and electronic business systems.

In an alternate embodiment, the system works with the Business Partner Network (BPN). BPN is the single source for vendor data for the Federal Government. BPN provides a search mechanism that provides unprecedented views into several key data bases across Federal Agencies. In yet another embodiment, the system works with both CCR and BPN databases.

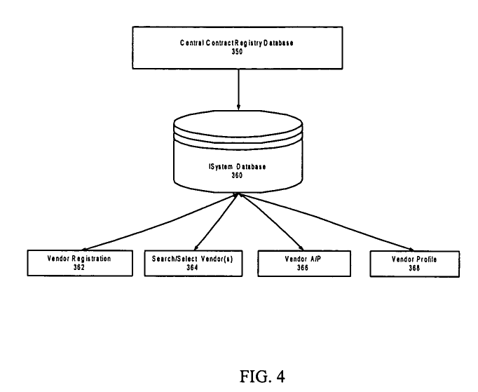

FIG. 4 illustrates an exemplary communications network between the CCR Database 350 and a system database for handling orders 360. The system database 360 in turn communicates with a vendor registration module 362, a vendor search/select module 364, a vendor account payable module 366, and a vendor profile module 368. The information from the CCR database 350 is used to
1. Facilitate Registration of Vendors
2. Search and Select Vendors for solicitation of services and/or delivery of supplies.
3. View Vendor Profile
4. Electronic Transfer Funds for outstanding A/P.

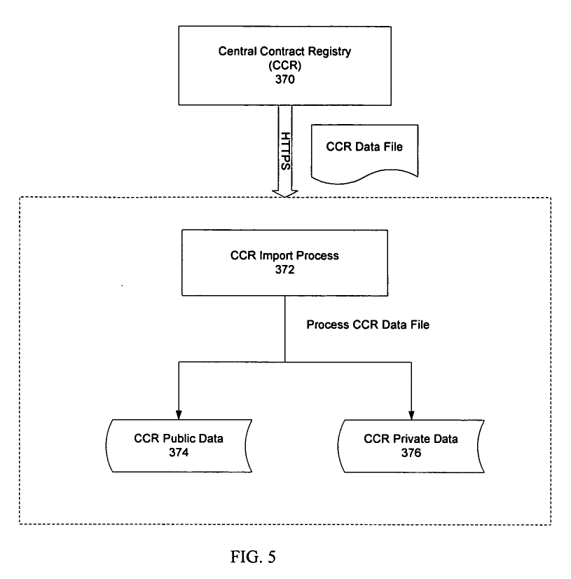

FIG. 5 illustrates an exemplary CCR update process. CCR Data File (which can include either full database or incremental (delta) changes) are downloaded from Central Contract Registry FTP site on a periodic basis. The data file is then processed by the CCR Import Process and data is loaded into CCR Public and CCR Private data tables. First, through a secure communication, a CCR data file is transmitted over an Internet connection to the server of FIG. 1B (370). Next, the CCR data is imported and processed (372). The data is separated into a CCR public data file (374) and a CCR private data file in the system database 360 (376).

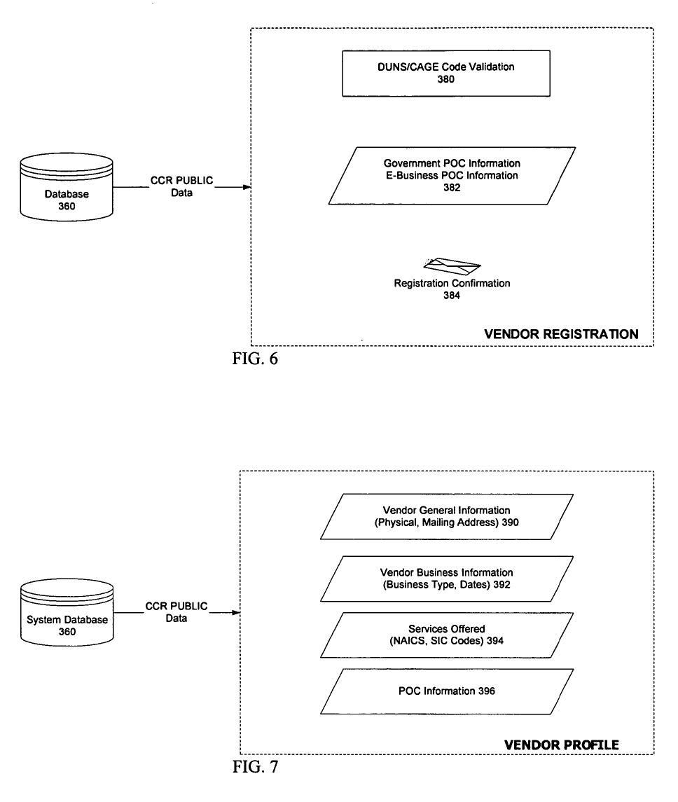

FIG. 6 illustrates an exemplary vendor registration process. In this process, the system database 360 uses the public data to check data entered by a new vendor. The process verifies that the DUNS/CAGE code matches (380). Next, the process checks the government Point of Contact (POC) information and the E-business POC information (382). If the information is verified, the process sends a registration confirmation (384). If not, an error message is sent to the vendor. Thus, the vendor registration process uses CCR Public Data to validate vendor DUNS/CAGE, to display Point of Contact information, and to send registration confirmation/welcome message to the email listed in CCR database. The Commercial And Government Entity (CAGE) code is a five character ID number used extensively within the Federal Government. CCR is an authorized source for the assignment of CAGE Codes. CAGE Codes will be assigned to vendors as their CCR registration goes through the validation process. The Data Universal Numbering System (DUNS) number is a unique nine character identification number provided by the commercial company Dun & Bradstreet (D&B). Telephone information for the vendor is also stored.

FIG. 7 shows an exemplary vendor profile process. In this process, the Vendor Profile process uses CCR Public data to show General Vendor Information (like Mailing, Physical address) (390). The process also displays Business Information such as type of business and business categories (392). The process also shows services offered by the vendor (394) and a Point of Contact Information (396). A rule-based Terms and Conditions (T/C) system uses meta-data from a Government Data Repository to map T/C to aspects of any or all transactions between Buyer and Seller.

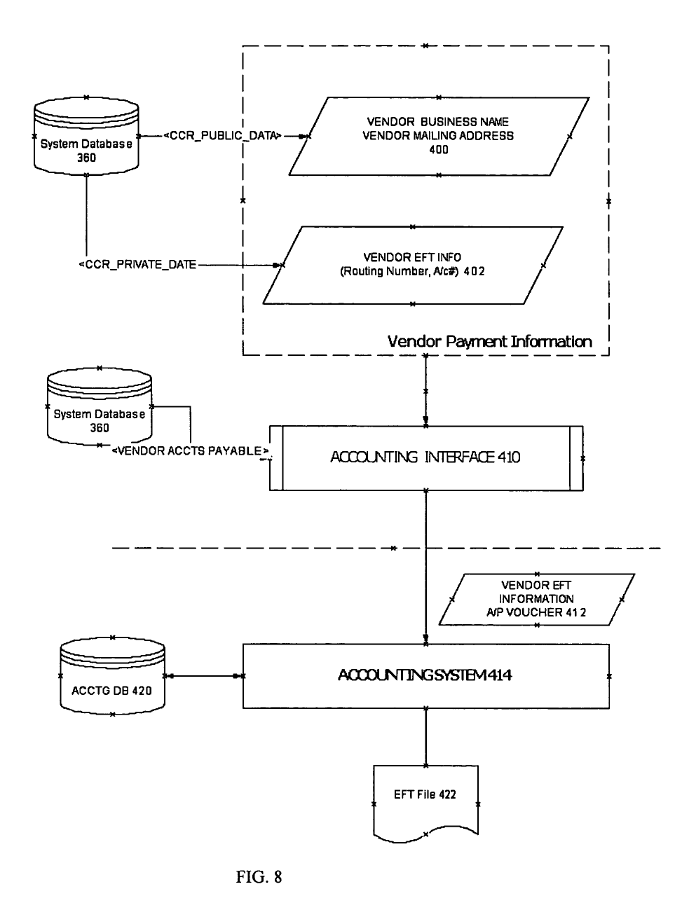

FIG. 8 shows a vendor payment process. In this process, the system's account payable module retrieves CCR Data to get an Electronic Funds Transfer Information for the vendors. When properly executed Electronic Funds Transfer (EFT) makes for a faster more efficient method of payment. The Defense Finance and Accounting Service (DFAS), receives, on a daily basis, vendor financial information found in CCR. DFAS uses the CCR information make the vendor payments.

In the embodiment of FIG. 8, CCR public data and private data are retrieved from the system database 360. The public data is used to determine the vendor's business name and mailing address (400). The private data is used to determine the vendor's EFT information such as Routing Number and Account number, among others (402). The contact information and bank information (vendor payment information) is provided to an accounting system (in this embodiment a Costpoint system) through an interface 410. The interface 410 also receives the amount of the account payable to the vendor from the system database 360. The payment information is formatted to include vendor EFT information and Account Payable voucher (412). The accounting system receives the payment data (414) and other information from the accounting system database (420). The process then electronically sends the EFT file to pay the vendor (422).

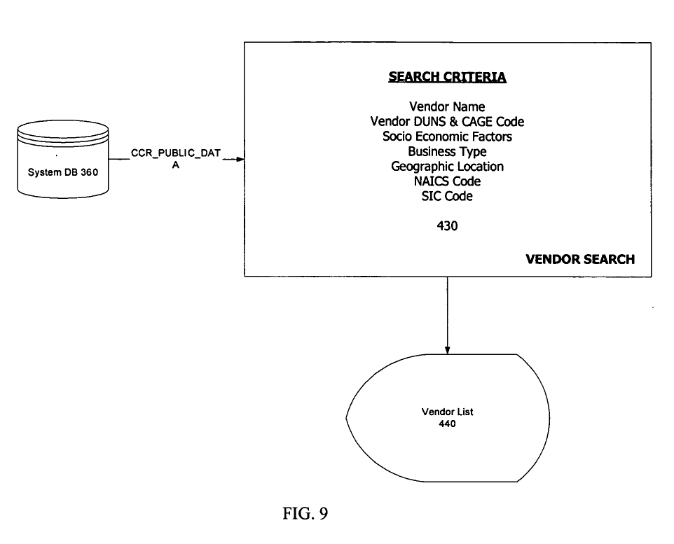

FIG. 9 shows an exemplary process to locate a particular vendor. First, CCR public data is retrieved from the system database 360. Next, a query is performed (430) where the search criteria may include Vendor Search includes one or more of the following search criteria:
1. Business Name
2. DUNS and CAGE Code
3. Socio Economic Factors
4. Business Type
5. Geographic Location
6. NAICS/SIC Code

Based on the value of the criteria selected, the system matches the vendor using CCR Data and displays the matching vendors in a vendor list (440).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A system to support an electronic market place, comprising:
a communication network to communicate buying and selling requests between buyers and vendors;
a buyer for the government coupled to the network to issue a purchase order and to provide a credit card number; and
a server coupled to the network to receive the purchase order, the server charging the credit card number for the purchase order, the server further accessing data from a Central Contract Registry (CCR) Database to retrieve vendor payment data for paying the vendor.

2. The system of claim 1, further comprising means for tracing and auditing each transaction.

3. The system of claim 2, further comprising means for keeping a local copy of the CCR database in a system database.

4. The system of claim 2, further comprising means for importing the CCR data into a public data storage and a private data storage.

5. The system of claim 4, wherein the importing means further comprises means for transferring data over a secure protocol.

6. The system of claim 2, further comprising means for using the CCR data to Register Vendors, Search and Select Vendors for solicitation of services and/or delivery of supplies; View Vendor Profile; or Electronic Transfer Funds for outstanding account payable.

7. The system of claim 6, wherein the vendor registration further comprises means for validating the vendor's DUNS/CAGE data and Point of Contact data.

8. The system of claim 6, wherein the view vendor profile further comprises means for displaying Business Name; DUNS and CAGE Code; Socio Economic Factors; Business Type; Geographic Location; or NAICS/SIC Code.

9. The system of claim 6, wherein the search vendor profile further comprises means for receiving as a search parameter one or more of the following:
Business Name; DUNS and CAGE Code; Socio Economic Factors; Business Type; Geographic Location; and NAICS/SIC Code.

10. The system of claim 6, further comprising
means for retrieving CCR public data and private data;
means for determining the vendor's business name and mailing address from the public data;
means for determining the vendor's electronic fund transfer (EFT) information from the private data; and
means for using the EFT information to pay the vendor.

11. A computer-implemented method to fulfill an order, comprising:
receiving a government electronic purchase order with a credit card number;
charging the credit card number for the order;
accessing data from a Central Contract Registry (CCR) Database to retrieve vendor payment data; and
paying the vendor using the CCR database.

12. The method of claim 11, further comprising providing an audit trail for each purchase order.

13. The method of claim 12, further comprising keeping a local copy of the CCR database in a system database.

14. The method of claim 12, further comprising importing the CCR data into a public data storage and a private data storage.

15. The method of claim 14, wherein the importing further comprises transferring data over a secure protocol.

16. The method of claim 12, further comprising using the CCR data to Register Vendors, Search and Select Vendors for solicitation of services and/or delivery of supplies; View Vendor Profile; or Electronic Transfer Funds for outstanding account payable.

17. The method of claim 16, wherein the vendor registration further comprises validating the vendor's DUNS/CAGE data and Point of Contact data.

18. The method of claim 16, wherein the view vendor profile further comprises displaying Business Name; DUNS and CAGE Code; Socio Economic Factors; Business Type; Geographic Location; or NAICS/SIC Code.

19. The method of claim 16, wherein the search vendor profile further comprises receiving as a search parameter one or more of the following: Business Name; DUNS and CAGE Code; Socio Economic Factors; Business Type; Geographic Location; and NAICS/SIC Code.

20. The method of claim 16, further comprising
retrieving CCR public data and private data;
determining the vendor's business name and mailing address from the public data;
determining the vendor's electronic fund transfer (EFT) information from the private data; and
using the EFT information to pay the vendor.
